(19) United States
(12) Patent Application Publication
(10) Pub. No.: US 2007/0143766 A1
(43) Pub. Date: Jun. 21, 2007

(54) Deadlock detection in a computing environment

(75) Inventors: Eitan Farchi, Pardes Hana (IL); Alexander Krits, Haifa (IL); Yarden Nir-Buchbinder, Haifa (IL)

Correspondence Address: Stephen C. Kaufman;IBM Corporation, Intellectual Property Law Dept., P.O. Box 218, Yorktown Heights, NY, 10598, US

(73) Assignee: International Business Machines Corporation, Armonk, NY (US)

(21) Appl. No.: 11/314,132

(22) Filed: Dec. 21, 2005

(51) Int. Cl. G06F 9/46

(52) U.S. Cl. 718/104

(57) ABSTRACT

A method and system for detecting deadlock is provided. A second thread monitors a first thread's attempts to lock or release resources in a computing execution environment. A deadlock is detected in response to the second thread determining that the first thread failed to lock or release a resource as expected.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to multiprocessing computing environments and, more particularly, to a system and method for detecting potential deadlocks in a multiprocessing environment.

### BACKGROUND

In a multiprocessing computing environment, more than one process may actively use the resources available in the computing environment. To avoid corruption of a resource due to the concurrent use or modification by multiple processes, a process may lock a resource and release the lock after the process has finished using the process.

In some situations, a deadlock occurs when two processes or two elements (e.g., threads) in a process are each waiting for the other to release a lock, before one can continue. Occurrence of a deadlock is disruptive. Thus, software applications and multiprocessing environments in which the applications operate are typically tested to determine and prevent deadlocks.

A methodology called a lock discipline may be used to avoid deadlock. A lock discipline defines the order in which a plurality of processes or threads may lock a plurality of resources in a concurrent/parallel processing environment. According to the lock discipline, when several locks need to be taken together, each lock is taken in a predefined order so that all active processes or threads may share resources without creating a deadlock situation.

A lock discipline may be graphically represented as a directed graph, having multiple nodes and edges that connect the nodes. Nodes in the graph represent the locks. An edge connecting a first node A to a second node B, for example, represents the possibility of taking consecutive locks A and B (i.e., B nested within A). Once a lock discipline is defined for a given system, it is desirable to have a tool that will indicate whether the system indeed adheres to the lock discipline.

NASA's Java PathFinder (JPF)¹⁹⁸ is one such tool that uses dynamic analysis to monitor locks taken by a plurality of threads at runtime. JPF uses a special Java Virtual Machine (JVM)^{™} to determine the threads and the order in which the locks are taken, so that violations of lock discipline can be revealed. JPF is especially suited for analyzing multi-threaded Java applications, where normal testing usually falls short. JPF can find deadlocks and violations of Boolean assertions stated by the programmer in a special assertion language. (See Visser, Havelund, Brat, Park and Lerda: “Model Checking Programs,” Journal of Automated Software Engineering, 10(2): 203-232, April 2003.)

IBM's ConcurrentTesting (ConTest)^{™} is another tool that traces lock taking and releasing by threads, and provides a post-test analysis of the traces to reveal violations of the discipline. ConTest is applied by instrumenting the bytecode of the application around places that are likely to be involved in concurrent bugs. ConTest run-time engine is called through the instrumentation. The engine adds heuristically controlled conditional sleep and yield instructions within the program. These instructions help reveal concurrent bugs. (See http://www.alphaworks.ibm.com/tech)

Both of the above approaches can identify violations of the lock discipline based on a directed graph. Unfortunately, however, both approaches are intrusive. That is, each tool requires special instrumentation of the program code or modification of the runtime environment, and thus intervenes in program execution in a natural environment. For the above reasons, said tools cannot be used during advanced testing phases and in the field where special instrumentation of the code or modification of the environment are not viable options.

Thus, a deadlock analysis and prevention method and system is needed that can overcome the aforementioned shortcomings of the related art techniques.

### SUMMARY

The present disclosure is directed to a system and corresponding methods that facilitate detecting potential deadlocks in a multiprocessing execution environment. In accordance with one aspect of the invention, a second thread monitors a first thread's attempts to lock or release resources in an execution environment. A deadlock is detected in response to the second thread determining tha the first thread failed to lock or release a resource as expected.

For purposes of summarizing, certain aspects, advantages, and novel features of the invention have been described herein. It is to be understood that not all such advantages may be achieved in accordance with any one particular embodiments of the invention. Thus, the invention may be embodied or carried out in a manner that achieves or optimizes one advantage or group of advantages without achieving all advantages as may be taught or suggested herein.

In accordance with one embodiment, a method for detecting deadlock in a computing execution environment is provided. The method comprises attempting to take a first lock and a second lock using a first thread; monitoring status of at least one of the first lock and the second lock using a second thread; and detecting a deadlock, in response to the second thread determining expiration of a threshold associated with the status of at least one of the first lock and the second lock.

In accordance with an exemplary embodiment, a system for detecting deadlock in a computing execution environment comprises at least one of a software program, a logic unit or circuit for monitoring a first thread and for reporting the first thread's attempt to lock or release a resource to a second thread running in parallel with the first thread. A software program, logic unit or circuit for determining a deadlock, in response to the first thread failing to lock or release the resource after a time threshold expires may be also included.

In accordance with yet another embodiment, a computer program product comprising a computer useable medium having a computer readable program is provided. The computer readable program when executed on a computer causes the computer to attempt to take or release a lock using a first thread. The status of the lock is monitored by a second thread, and a deadlock is detected by way of the second thread determining expiration of a threshold associated with the status the lock.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary software environment in accordance with one or more embodiments of the invention.

FIG. 2 is a flow diagram of a method for detecting deadlock, in accordance with one or more embodiments.

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF PREFERRED EMBODIMENTS

The present disclosure is directed to systems and corresponding methods that facilitate detecting potential deadlocks in a multiprocessing system by way of implementing at least two auxiliary threads. One thread is configured for monitoring status of locks taken or released by the other thread, and reports a deadlock when the other thread fails to successfully complete execution, due to a violation of the system's lock discipline.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

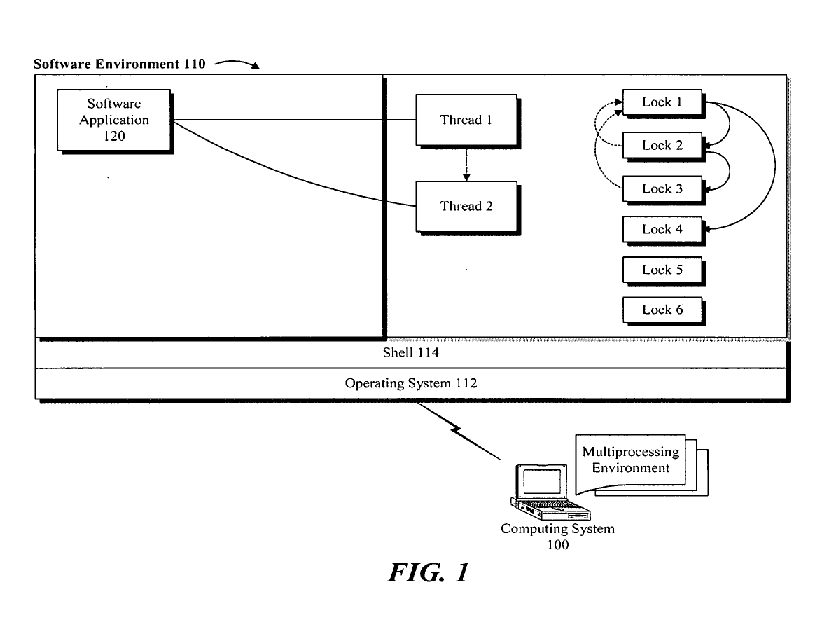

Referring to FIG. 1, an exemplary runtime environment is provided in the context of software environment 110. Software environment 110 includes an operating system 112 having a shell 114 loaded onto a computing system 100. In accordance with one aspect of the system, the software environment 110 supports a multiprocessing environment in which a multithreaded software application 120 can be executed on top of operating system 112.

According to one aspect of the invention, software application 120 is implemented to instantiate multiple threads (e.g., threads 1 and 2) that can run in parallel to detect deadlock in a system under test. A system under test may be a logic code, software application, program code or other executable method in a computing environment. To test a system, preferably, the lock discipline for the system is provided as input to software application 120. The lock discipline may be either provided by a user or determined based on results generated by other test programs used to analyze the system.

An exemplary lock discipline may be graphically represented by a number of nodes and edges connecting the nodes. As shown in FIG. 1, for example, each node preferably represents a lock taken by a thread or process, and each edge represents whether or not one or more locks may be taken in sequence without violating the lock discipline. Nodes 1 through 6 represent the locks (e.g., L1, L2, . . . , L5, L6) and the edges between the nodes (e.g., L1−>L2, L2−>L3, etc.) represent that a thread can concurrently take a plurality of locks in the illustrated sequence, without violating the lock discipline.

It should be noted that the exemplary lock discipline graph, in FIG. 1, includes nodes without edges (e.g., L5 and L6) to represent locks which are mea nt to be taken in isolation. In certain embodiments, the lock discipline graph may not be complete with regards to all nodes in the tested system. That is, some locks ar not included in the lock discipline graph, so that the system may be tested partially or with respect to specific locks. In a preferred embodiment, however, the graph is complete with regards to edges between the represented locks and contains all locks which may be taken together.

In one embodiment, the software application 120 is implemented to instantiate at least two auxiliary threads, a first thread (T1) and a second thread (T2). T1 and T2 are preferably executed in the same runtime environment as the system under test. Thus, in accordance with certain embodiments of the invention, the runtime environment is not modified and the program code for the tested system is not specially instrumented.

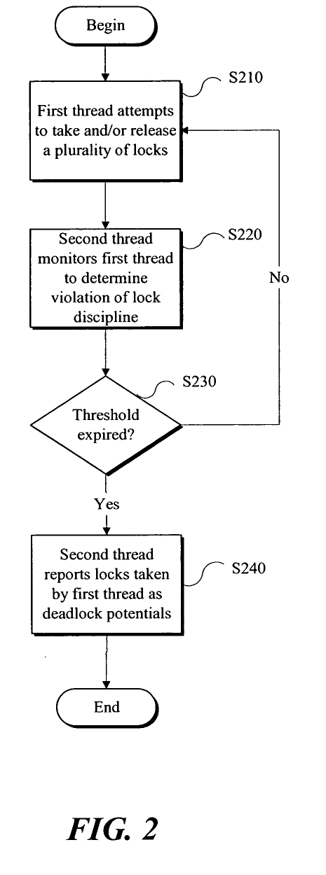

Referring to FIGS. 1 and 2, to determine potential deadlock in the system, T1 attempts to take or release a plurality of locks (S210). Preferably, T1 repeatedly takes or releases one or more locks in during several iterations. For example, T1 may attempt to take two locks L1 and L2, among the six locks illustrated in the exemplary lock discipline graph. Provided that, in taking the plurality of locks, a closed cycle is not created in the lock discipline graph, one or more edges are added to the graph to represent the respective locks taken by T1 during each test iteration.

For example, if T1 takes a first lock L1 and nestedly a second lock L2, the edge L1−>L2 may be added to the graph, if it was not included originally. However, in the exemplary discipline graph shown in FIG. 1, T1 will not take lock L1 subsequent to taking lock L2, since the edge L2−>L1, if added, will result in closing a cycle (i.e., L1−>L2−>L1). Accordingly, software application 120 is implemented to detect such potentials for closed cycles (i.e., deadlock) in advance and to prevent T1 from taking locks in violation of the lock discipline.

To detect potential deadlocks, software application 120 is implemented to instantiate a second thread (T2) to monitor T1 and to determine violation of the lock discipline, in advance (S220). It is noteworthy that in some embodiments, additional monitoring threads (e.g., T3, T4, T5,etc.) may be instantiated to monitor a lock-taking thread T1.

Likewise, it is also possible that more than one lock-taking thread is implemented. In the following, however, an exemplary embodiment of the invention is disclosed as using a single thread T2 to monitor a single lock-taking thread T1. This exemplary embodiment should not be construed to limit the scope of the invention to the use of a single monitoring thread, however.

In one or more embodiments, T1 and T2 are implemented to communicate status of locks taken or released. For example, T1 reports to T2 status of locks T1 is attempting to take or release, during each iteration, and prior to T1 actually taking or releasing a lock. In some embodiments, T1 also reports to T2 status of locks T1 has actually taken or released during each iteration.

Accordingly, in a preferred embodiment, T2 receives lock status information from T1 about locks held by T1, and locks T1 is attempting to take or release during a subsequent iteration. Thus, T2 receives lock status information about one or more locks to be held or released by T1, prior to the locks actually being taken or released. Accordingly, T2 can determine progress of T1 based on the information provided during each iteration about prospective future status of locks and the present status of locks held or released by T1.

In certain embodiments, a threshold (e.g., a time constraint) is associated with the locks being held or released, such that T1's failure to release or take a lock signals to T2 the possibility of violation of the lock discipline. For example, T2 may be implemented to start a countdown toward a predefined time-out threshold, after receiving a lock status from T1. If the threshold expires before T1 manages to make any progress by either taking or releasing a lock as expected (S230), then T2 determines that a deadlock has occurred.

If T2 detects a deadlock, in a preferred embodiment, T2 reports locks taken or attempted by T1, at the time, as deadlock potentials (S240). Otherwise, if prior to the expiration of the threshold, T2 receives lock status information that indicates T1 has successfully progressed (e.g., released or taken a lock as expected), then no deadlock is detected and T1 moves on to the next iteration (S210). In certain embodiments, the lock discipline graph may be modified according to the locks reported by T2 as potentially violating the lock discipline.

Referring to FIG. 1, for the purpose of example, let us assume that T1 concurrently holds locks L1, L2 and L3, such that L3 is nested within L2 and L2 is nested within L1. This may be represented as L1−>L2−>L3. Since the lock discipline graph already includes the edge L1−>L2, during an iteration T1 would not take lock L1 nested within L2 (e.g., L2−>L1), as it would violate the defined lock discipline. In accordance with one embodiment of the invention, however, T1 may take lock L4 without violating the lock discipline.

In this example, the lock discipline graph does not contain a direct edge between L1 and L3 (e.g., L1−>L3), therefore T1 may attempt to take a lock on L1 nested within L3 (i.e., L3−>L1) without violating the lock discipline. Considering the lock status scenario represented by L1−>L2−>L3, however, if T1 takes a lock L1 nested within L3 a deadlock occurs as this will result in a closed cycle (i.e., L1−>L2−>L3−>L1).

As indicated earlier, according to a preferred embodiment, prior to attempting to lock L1 nested in L3, T1 notifies T2 of this attempt. Thus, in a current iteration in the above example, T2 will receive the following lock status information:

| | |
|---|---|
| T1 holds L1−>L2−>L3 | T1 attempts L3−>L1 |

In a subsequent iteration, when T1 attempts a lock on L1 nested within L3(L3−>L1), T1 enters a deadlock state, unable to progress any further. In a deadlock state, T1 cannot function to generate any reports to identify the locks involved in the deadlock. However, since T2 is a thread that is still executing, T2 has information about the locks held by T1 and can generate a deadlock report, after T2 detects that T1 has not made any progress (e.g., T1 has failed to take the locks represented by edge L3−>L1) as expected.

In another embodiment, a failure in the progress of the first thread is determined if the thread fails to release a lock. For example, consider a scenario where T1 holds a lock on L1 and L2, and T1 attempts to release L2 prior to taking L3. T2 can be implemented to detect a deadlock potential if after expiration of a threshold, T1 has failed to release L2.

In accordance with one aspect of the invention, the first and second threads (T1, T2 ) may be implemented as additional auxiliary threads within the program being tested. This may take additional processor time and result in some runtime penalty on the system's threads. This penalty can be parameterized by, for example, deactivating T1 some time between iterations, when it is not holding any locks.

In certain embodiments, future lock potentials for T1 during each iteration are randomly selected. In alternative embodiments, a heuristic approach may be implemented to select future locks. Also, depending on implementation, T1 may attempt to take a plurality of nested locks during each iteration, releasing none or a few locks before moving to a subsequent iteration. In one implementation, a first lock may be taken in association with a second lock, wherein one of the locks is released before a third lock is taken, during a subsequent iteration.

In a preferred embodiment, a minimal number of locks (e.g., two locks) are taken during each iteration by T1. Thus, when a deadlock report is generated by T2, a minimal number of locks with deadlock potential are identified, advantageously making it easier to update the lock discipline graph during each iteration. A report including a large number of locks with deadlock potential may require further or more detailed analysis, but may never the less be implemented in certain embodiments.

In an exemplary embodiment, where the system under test is a java program with synchronizations, the tool according to the invention can be activated by invoking an application programming interface (API) and specifying the synchronization objects. In another exemplary embodiment, if the locks are implemented as operating system file locks specified by a naming convention, then the tool according to one embodiment of the invention may run as an independent process.

In either embodiment, the tool is implemented such that it does not intervene with the environment's runtime architecture, and there is no need to specially instrument the systems code. Thus, the present invention is advantageously deployable in late test phases or even in the field, without interfering with the test environment or requiring undue instrumentation of the program code.

In different embodiments, the invention can be implemented either entirely in the form of hardware or entirely in the form of software, or a combination of both hardware and software elements. For example, computing system 100 and software environment 110 may comprise a controlled computing system environment that can be presented largely in terms of hardware components and software code executed to perform processes that achieve the results contemplated by the system of the present invention.

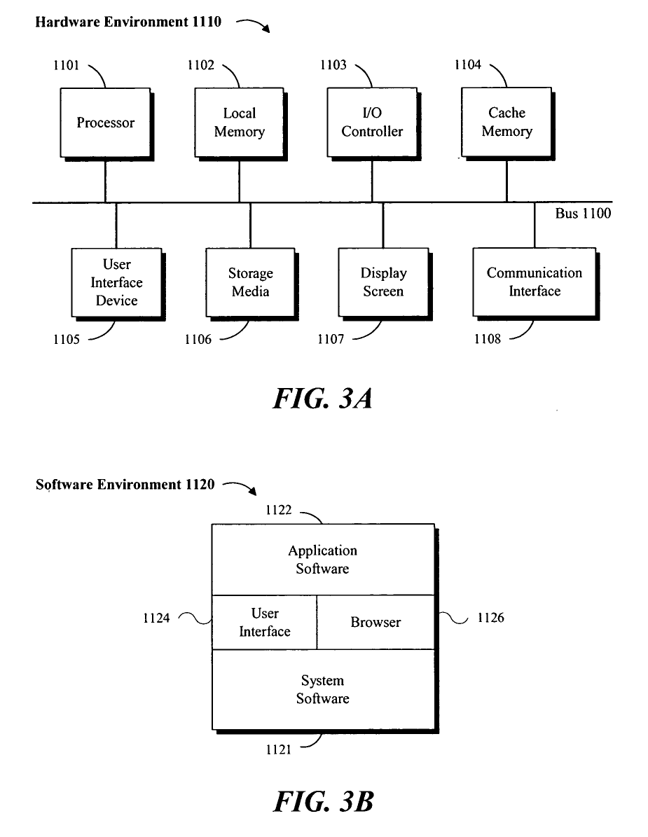

Referring to FIGS. 3A and 3B, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. System software 1121 comprises control programs, such as the operating system (OS) and information management systems that instruct the hardware how to function and process information.

In a preferred embodiment, software application 120 is implemented as application software 1122 executed over hardware environment 1110 to detect a deadlock in a multiprocessing computing environment, as provided earlier. Application software 1122 may include but is not limited to firmware, resident software, microcode, etc.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or devise.

The computer-readable medium can be an electronic, magnetic, optical, electromagnetic, infrared, or semiconductor system (or apparatus or devise) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD/W) and digital video disk (DVD).

Referring to FIG. 3A, an embodiment of the application software 1122 can be implemented as computer software in the form of computer readable code executed on a data processing system such as hardware environment 1110 that comprises a processor 1101 coupled to one or more memory elements by way of a system bus 1100. The memory elements, for example, can comprise local memory 1122, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicating with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 3B, application software 1122 can comprise one or more computer programs that are executed on top of system software 1121 after being loaded from storage media 1106 into local memory 1102. In a client-server architecture, application software 1122 may comprises a client software and a server software. For example, in one embodiment of the invention, client software is executed on computing system 100 and server software is executed on a server system (not shown).

Software environment 1120 may also comprise browser software 1126 for processing data available over local or remote computing networks. Further software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, process methods and the order in which the respective steps of each method are performed are purely exemplary. Depending on implementation, the steps can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention and are further defined by the claims and their full scope of equivalents.

What is claimed is:

1. A method for detecting deadlock in a computing execution environment, the method comprising:
attempting to take a first lock and a second lock using a first thread;
monitoring status of at least one of the first lock and the second lock attempted to be taken using a second thread; and
detecting a deadlock, in response to the second thread determining expiration of a threshold associated with the status of at least one of the first lock and the second lock.

2. The method of claim 1, further comprising reporting a deadlock state for the first thread, in response to the second thread detecting the deadlock.

3. The method of claim 2, further comprising identifying at least one of the first lock and the second lock in the deadlock state.

4. The method of claim 1, wherein the first thread reports to the second thread an attempt to lock a resource.

5. The method of claim 1, wherein the first thread reports to the second thread an attempt to release a resource.

6. The method of claim 1, wherein the second thread detects the deadlock, in response to the first thread failing to lock or release a resource as expected.

7. The method of claim 1, wherein the threshold expires, in response to determining that the status of at least one of the first lock and the second lock is unchanged after a predetermined time has elapsed.

8. The method of claim 1, wherein the status of at least one of the first lock and the second lock is associated with whether the first thread successfully takes the second lock.

9. The method of claim 1, wherein the status of at least one of the first lock and the second lock is associated with whether the first thread successfully releases the second lock.

10. The method of claim 1, wherein the threshold expires in response to:
the first thread successfully taking the first lock and attempting to take the second lock;
the first thread reporting the attempt to take the second lock to the second thread; and
the first thread failing to report taking the second lock to the second thread after a predetermine time elapses.

11. The method of claim 1, wherein the threshold expires in response to:
the first thread successfully taking the first and second locks and attempting to release the second lock;
the first thread reporting the attempt to release the second lock to the second thread; and
the first thread failing to report releasing the second lock to the second thread after a predetermine time elapses.

12. A system for detecting deadlock in a computing execution environment, the system comprising:
a first logic unit for monitoring a first thread and for reporting, the first thread's attempt to lock a resource, to a second thread running in parallel with the first thread; and
a second logic unit for determining a deadlock, in response to the first thread failing to lock the resource after a time threshold expires.

13. A system for detecting deadlock in a computing execution environment, the system comprising:
a first logic unit for monitoring a first thread and for reporting, the first thread's attempt to release a locked resource, to a second thread running in parallel with the first thread; and
a second logic unit for determining a deadlock, in response to the first thread failing to release the locked resource after a time threshold expires.

14. A computer program product comprising a computer useable medium having a computer readable program, wherein the computer readable program when executed on a computer causes the computer to:
attempt to take or release a lock using a first thread;
monitor status of the lock using a second thread; and
detect a deadlock, by way of the second thread determining expiration of a threshold associated with the status of the lock.

15. The computer program product of claim 14, wherein the computer readable program when executed on a computer further causes the computer to report a deadlock state for the first thread, in response to the second thread detecting the deadlock.

16. The computer program product of claim 14, wherein the computer readable program when executed on a computer further causes the computer to identify the lock, when reporting the deadlock state.

17. The computer program product of claim 14, wherein the first thread reports to the second thread an attempt to take or release the lock.

18. The computer program product of claim 14, wherein the threshold expires, in response to determining that the status of the lock is unchanged after a predetermined time has elapsed.

19. The computer program product of claim 14, wherein the threshold expires in response to:
the first thread reporting an attempt to take the lock to the second thread, and
the first thread failing to report taking the lock to the second thread after a predetermine time elapses.

20. The computer program product of claim 14, wherein the threshold expires in response to:
the first thread reporting an attempt to release the lock to the second thread; and
the first thread failing to report releasing the lock to the second thread after a predetermine time elapses.
